(19) United States
(12) Patent Application Publication
(10) Pub. No.: US 2014/0280623 A1
(43) Pub. Date: Sep. 18, 2014

(54) AUTO-REPLY EMAIL SYSTEM AND METHOD WITH PERSONALIZED CONTENT

(71) Applicant: Xiaojiang Duan, Beijing (CN)

(72) Inventor: Xiaojiang Duan, Beijing (CN)

(21) Appl. No.: 13/834,696

(22) Filed: Mar. 15, 2013

(51) Int. Cl. H04L 12/58

(52) U.S. Cl. CPC H04L 51/04
USPC 709/206

(57) ABSTRACT

An auto-reply electronic mail message with personalized content. Text is extracted from an inbound email message. The text is used for chatbot input messages. Chatbot output messages are generated. The chatbot output messages are composed. The composed messages are formed into a responsive outbound email communication.

A computer program listing appendix is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to communication systems and methods and more specifically to electronic email and chatbot communication systems and methods for generating personalized content email messages.

Electronic mail (“email”) is now ubiquitous. Individuals, businesses, governmental agencies, establishments and other such entities now utilize email as their primary mode of communication. In particular, many businesses ranging from small companies to large Fortune 500 corporations rely on email for customer service because such entities can communicate quickly and can concurrently disseminate information to a larger audience while serving a larger customer base.

A typical customer can use email messages to communicate multiple times with a business. It is also not unusual to send email messages to business after hours. For merchants without round-the-clock customer service, emails received after hours are not processed until the subsequent business day.

Yet other merchants might have insufficient resources to respond to emails even during regular business hours. Even larger business entities can become overwhelmed by numerous email messages. Some businesses resolve this issue by simply queuing up the email messages for processing. Yet other businesses utilize auto-reply email messages that do no more than provide a confirmation of receipt.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of a system and method for generating email replies with personalized content can be found in exemplary embodiments of the present invention.

In a first embodiment, an outbound email communication is automatically generated responsive to a received inbound email communication. Here, the inbound email message might include text information such as an inquiry, question, follow-up, etc. from a user, customer, client or the like.

In this embodiment, the method of the present invention determines the portion of text information from the inbound email message that is then extracted. The extracted portion might meet one or more criteria in order to be extracted. The extraction itself, in one embodiment, may be accomplished by using a list of text patterns for filtering.

After it is extracted, the extracted text is configured into one or more sentences that are used as input messages for a chatbot. The one or more sentences are used as chatbot input messages to generate corresponding output messages.

In one embodiment, the output messages are responsive to the input messages. In other instances, the input messages may have no corresponding output messages. The output messages, if any, are then used for composing an outbound email message that is transmitted to the user, client, customer or the like.

In this manner, the transmitted outbound email message includes output messages that are responsive to sentences in the inbound email message to provide personalized responses to such inbound email messages, unlike conventional auto-reply systems that do no more than provide a confirmation of receipt. This is but one exemplary advantage of the present invention.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates a communication system according to an exemplary embodiment of the present invention.

FIG. 2 illustrates an alternate communication system according to an exemplary embodiment of the present invention.

FIG. 3 illustrates a chatbot system illustrating internal components of the chatbot system of FIG. 1 according to an exemplary embodiment of the present invention.

FIG. 4 illustrates a personalized email response method/sequence according to an exemplary embodiment of the present invention.

FIG. 5 illustrates an exemplary inbound email message.

FIG. 6 illustrates an exemplary outbound email message according to an exemplary embodiment of the present invention.

7A shows a typical computer such as would be operated by a user on the Internet and suitably programmed using one or more lines of code to execute embodiments of the present invention.

FIG. 7B shows subsystems of the computer of FIG. 7A.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

FIG. 1 illustrates communication system 100 according to an exemplary embodiment of the present invention.

In FIG. 1, communication system 100 comprises user 102 communicably coupled to merchant system 114 via Internet/communication network 106. User 102 represents a customer browsing website 120 to explore products and/or services offered by merchant system 114. Here, website 120 is served up by web server 116 of merchant system 114.

User 102 can represent other types of clientele such as wireless customer, cable services customer or the like. Such a user might contact a service provider via email to inquire about an existing service.

In FIG. 1, Internet/communication network 106 represents any distributed network (wired, wireless or otherwise) for data transmission and receipt between/among two or more points. Although not shown, Internet/communication network 106 might represent a direct or local connection between end users and merchant systems.

In FIG. 1, user 102 utilizes mobile device 104 to communicate with merchant system 114 when, for example, user 102 wishes to request information about a product. Mobile device 104 is a portable communication device such as a smart phone or the like.

In one embodiment, the communication with merchant system 114 might occur using an electronic email application (not shown). In another embodiment, user 102 uses a browser form (not shown) or the like to contact the merchant.

In FIG. 1, user 124 represents another customer. Many customers can concurrently communicate with merchant system 114. Here, user 104 utilizes computing device 122 for communicating with merchant system 114 in a manner akin to user 102. Thus, user 124 can also utilize an email app or browser form to communicate with merchant system 114.

In turn, merchant system 114 can utilize email server 118 to respond to user email communications from users 102 and 124. Unlike prior art systems, merchant system 114 is operable in conjunction with chatbot system 108 to provide personalized responses to user email communication received from users 102 and 124.

Chatbot system 108 receives input messages emanating from user email communications and provides corresponding output responses. An example of chatbot system 108 is disclosed in the following co-pending applications all of which are commonly owned by the present assignee and all of which are hereby incorporated by reference in the present specification as if fully set forth herein:

U.S. patent application Ser. No. 13/661,040, entitled “Chatbot System and Method with Contextual Input and Output Messages” filed Oct. 26, 2012; U.S. patent application Ser. No. 13/661,042 entitled “Chatbot System and Method with Enhanced User Communication” filed Oct. 26, 2012; U.S. patent application Ser. No. 13/661,045 entitled “Chatbot System and Method with Interactive Chat Log” filed Oct. 26, 2012; U.S. patent application Ser. No. 13/661,046 entitled “Chabot System and Method Having Auto-Select Input Message with Quality Response” filed Oct. 26, 2012; and U.S. patent application Ser. No: 13/661,034, filed Oct. 26, 2012 entitled “User-Aided Chatbot Learning System And Method.”

In FIG. 1, communication system 100 further comprises email systems administrator 110 communicably coupled with email server 118 via computing device 112. Email systems administrator 110 is responsible for administering email server 118, performing updates and ensuring that email server 118 is up and running Email systems administrator 110 can also receive, review and edit auto-reply email responses to users 102 and 124 before the auto-reply email responses are sent out to users 102 and 104.

Briefly, in operation, users 102 and 124 wishing to communicate with merchant system 114 use their respective devices to generate email communication messages to merchant system 114. As an example, user 102 might be desirous of purchasing a product but might have a series of questions for merchant system 114.

User 102 sends the inquiry via email communication (not shown) to merchant system 114. Merchant system 114 receives the email communication via email server 118. Upon detecting the email communication, chatbot system 118 receives as input messages, applicable sentences from the email communication.

Corresponding output messages are generated based on the input messages and are automatically composed as email response messages (accessible by email systems administrator 110) that are then sent to users 102 and 124 responsive to their email communication inquiries.

FIG. 2 illustrates communication system 200 according to an exemplary embodiment of the present invention.

In FIG. 2, chatbot system 108 is integrated within merchant system 214 unlike the embodiment of FIG. 1. In this manner, the entirety of merchant system 214 is managed internally. Otherwise, communication system 214 comprises components as those described with reference to FIG. 1.

FIG. 3 illustrates chatbot system 308 according to an exemplary embodiment of the present invention.

In FIG. 3, among other components, chatbot system 308, an embodiment of chatbot system 108 of FIG. 1, comprises monitoring and extracting engines 330 and 332. Monitoring engine 330 monitors the merchant mailbox (not shown) for all inbound email communication. Merchants may be requested to provide their mailbox authentication information so that monitoring engine 330 can access the merchant mailbox and, in one embodiment, download inbound email communication from customers. In one embodiment, the IMAP (Internet Message Access Protocol) is used to access the inbound email communications.

Authentication information might include protocol, username, password, mail server address, port number, etc. Once an inbound email communication is detected, extracting engine 332 extracts its text for forwarding to sequencing engine 334, which converts the text into sequential sentences.

In FIG. 3, the sequential sentences are used as input messages for chat engine 336. Chat engine 336 in conjunction with processor 338 and memory 340 might then employ a response determination engine (not shown) or a pattern matching engine (not shown) to generate appropriate output messages for the received input messages.

In one embodiment, chat engine 336 uses AIML (Artificial Intelligence Markup Language). The AIML implementation is but an embodiment of the present invention; implementations utilizing other languages are employed as well. Here, AIML comprises several elements. A first element is category, which is a fundamental unit of knowledge. A category includes two or more elements (e.g., pattern and template). For example:

<category>

<pattern>WHAT IS YOUR NAME</pattern>
<template>My name is Eddy.</template>

</category>

When this category is loaded, a chatbot receiving an input “What is your name” can respond with “My name is Eddy.” Here, a pattern is a string of characters that can match one or more user inputs. A pattern such as “What is your name” matches only one input, whether upper or lower case. However, patterns can also contain wildcards; thus, “what is your *” can match many inputs such as “what is your objective,” what is your address,” etc. A template provides the response for a pattern. An example of a template is “My name is Eddy.” A template can also use variables. A template may be as simple as some literal text, like “My name is <bot name=“name”/>,” which substitutes the chatbot's name into the sentence, or “You said you are <get name=“userage”/> years of age,” in which the user's age is replaced in the sentence. Text formatting, conditional response (if then/else), and random responses are elements of templates. Templates can also use the srai element to redirect to another pattern.

<category>

<pattern>What is your name</pattern>
<template>My name is <bot name=“name”></template>

</category>
<category>

<pattern>WHAT IS YOUR GIVEN NAME</pattern>

<template>
<srai>What is your name</srai>

</template>

</category>

In the first category, the input “What is your name” receives the chatbot's name as a response. In the second category, the input “WHAT IS YOUR GIVEN NAME” is redirected to the category that matches the input “What is your name.” In essence, the two phrases are equivalent. Templates may include other content types that are processed by the chatbot user interface. As an example, a template may employ HTML (Hyper-Text Markup Language) tags for formatting. Clients not supporting HTML typically ignore the tag. Those skilled in the art will recognize that other techniques that can either substitute or supplement pattern matching may be employed.

After appropriate responses for input messages are determined, chat engine 336 then generates corresponding output messages for compose engine 344. In FIG. 3, compose engine 344 then creates a reply message responsive to the inbound communication email, inserts the output message from chat engine 336 for forwarding to email server 118 (FIG. 1). Subsequently, email server 118 transmits the reply message to the user.

Note that in FIG. 3, in one embodiment, knowledge database 342 may receive and store input messages and user-generated messages including the context for such messages. Many components of chatbot system 308 have been omitted to avoid unnecessarily complicating the description of the invention. It would be apparent to one skilled in the art that chatbot system 308 may comprise additional (or fewer) components as proves necessary for implementation.

FIG. 4 illustrates personalized email response method/sequence 400 according to an exemplary embodiment of the present invention.

In FIG. 4, specifically, method 400 permits auto-replay generation of personalized email responsive to an inbound email message. An example of an inbound message is inbound email message 500 further illustrated with reference to FIG. 5. An example of an outbound message (which is responsive to inbound email massage 500) is outbound email message 600 further illustrated with reference to FIG. 6.

Referring to method 400 of FIG. 4, at 402, inbound email message 500 is sent from user 102 (FIGS. 1 and 2) to email server 118. At 404, email server 118 receives inbound email message 500, which is then detected by monitoring engine 330 (FIG. 3) at 406.

At 406 specifically, monitoring engine 330 detects that inbound email message 500 has been delivered to the merchant's inbox (not shown) on email server 118 and subsequently forwards the received inbound email message 500 to extracting engine 332 (FIG. 3).

Initially, the merchant provides access to their mailbox for customer support. The required data might include protocol, user name, password, mail server address, port number, protocol. Monitoring engine 330 then monitors the mail box for inbound emails.

At 408, extracting engine 332 extracts the user's inquiry from the inbound email message. Specifically, extracting engine 332 extracts the requisite text from the inbound email message for forwarding to sequencing engine 334 (FIG. 3).

Here, as an example, in FIG. 5, extracting engine 332 (FIG. 3) extracts email body 506 of inbound email message 500 for forwarding to sequence engine 332. Header 502, salutation 504 and concluding sentence 508 are excluded. Here, email body 506 includes a statement 506A, inquiry 506B and inquiry 506C all of which are forwarded to sequence engine 332.

Text extraction depends upon the relevant language in which inbound email message 500 is written. For example, in the English language, extraction can be implemented by identifying and extracting a complete sentence that ends with a period, full stop, question mark or exclamation mark followed by a space or quotation mark and space. A period following abbreviations such as e.g. or i.e. is excluded and the preceding text is not recognized as a sentence.

In one embodiment, a list of patterns of text to exclude is created. Examples of excluded text might be opening messages such as “To whom it may concern,” or closing messages such as “Sincerely” or recipient names. In an alternate embodiment, two lists of text patterns are created. The first list is used to identify and exclude only the matched text such as those typically found in opening paragraphs of electronic mail messages. Examples are “To whom it may concern,” “Dear *,” “Hello,” etc.

The second list goes beyond the functionality of the first list. Specifically, the second list excludes matched text itself and all text following the matched text. The second list would exclude “Sincerely, John Adams” and would also exclude “Sincerely, John Adams, Vice President, Gaming Systems.”

The second list would also exclude “PS: my phone number is 510-555-5555,” “Thanks & best regards,” “Best regards,” etc. As can be seen, the second list is typically applicable to the concluding paragraph of an email message. Other excludable examples are “The name of user,” email signature, etc. Note that the aforementioned examples are not exhaustive and are simply intended to exemplify functionality of the first and second lists.

Extracting engine 332 uses the lists of patterns to filter inbound email message 500, discarding all text following the closing messages. Keyword match or regular expression might be used to implement exclusion.

At 410, sequencing engine 334 segments the extracted text (e.g., email body 506 of FIG. 5) into sentences and the sentences are sequenced for use as input messages for chat engine 336. Although not shown, sequencing engine 334 and extracting engine 332 can be integrated into a single component for extracting the text in sequence. Here, the input messages are fed into chat engine 336 one sentence at a time.

At 412, chat engine 336 generates output messages responsive to each sentence of the input message. If chat engine 336 has no response to a particular input sentence, a default output message can be generated. The output message may be a predetermined template response for inputs with no response. Alternatively, an output message or response might not be provided.

At 412, all of the output messages are sent to compose engine 344.

At 414, compose engine 344 composes a reply to inbound email message 500 based on the output messages from chat engine 336. The reply might be a list of responses from chat engine 336, each response following its corresponding inbound sentence. The inbound sentence can be marked with a prefix such as a right angled bracket “>” or other indicator that sets off the inbound sentence.

The reply may also include an opening paragraph and a closing paragraph. The paragraphs are formed from predetermined templates that can be edited by merchants themselves. In the event that chat engine 336 has no response to all of its inbound sentences, compose engine 344 might generate a default reply that simply confirms the receipt of inbound email message 500.

At 416, after a reply is composed by compose engine 344, the reply is sent out as outbound email message 600 responsive to inbound email message 500 from user 102. An exemplary outbound email message 600 is shown in FIG. 6.

As can be seen in FIG. 6, outbound email message 600 includes email body 606 that includes inquiries and responses to said inquiries. Specifically, the user's inquiry “Where are you based?” 506B (preceded by a prefix “>”) and its corresponding response “We′re based in Sunnyvale, Calif.” 606B are shown.

Similarly, inquiry “What is your refund policy?” 506C is also shown followed by its corresponding response “We′re sorry, after our free trial period, all fees are non-refundable.” 606C. Thus, unlike conventional systems, an embodiment of the present invention can generate automatic responses that include personalized content such as specific responses to particular inquiries without user intervention.

That is, this outbound email message 600 is automatically generated in response to receipt of inbound email message 500. Here, note that outbound email message 600 does not include a response to statement “I was browsing your website and I am interested in signing up” 506A of FIG. 5, as chat engine 336 does not have a corresponding response for that statement.

Learning from Human Reply

In one embodiment, the outbound email message 600 can be displayed to email systems administrator 110 (FIG. 1) before the message is transmitted to user 102. Here, outbound email message 600 (or the reply forming said message) is displayed as a list of inbound sentences, each inbound sentence having a corresponding response, if available, provided by chat engine 336. Email systems administrator 110 might choose to either not send the message or to perform edits and send the message.

If email systems administrator 110 chooses to send the outbound email message 600, the response can either be edited or a completely new response can be provided for those inbound sentences without a response. Once the edits are completed, communication system 100 (FIG. 1) transmits the reply through the merchant email accounts.

Contemporaneously, communication system 100 creates a content entry for each inbound sentence and corresponding response, for loading to chatbot system 108 (FIG. 1), which in certain instances can store entries in knowledge database 342 (FIG. 3). If entries with the same input message pattern exist, the existing entries are overwritten.

As an example, the following content entry might be created based on outbound email message 600 of FIG. 6:

User: Where are you based?

Chatbot: We′re based in Sunnyvale, Calif.

User: What is your refund policy.

Bot: We′re sorry, after our free trial period, all fees are non-refundable.

Note that the above content entry may also be created when merchants manually provide a reply to customers from their own email client. A merchant can compose the reply in the required format; for example, the quoted input message from customers begins with the > character and the corresponding output messages are placed in a paragraph following the input message.

Click to Teach

Merchants and their email system administrators can also teach chatbot system 108 to compose replies by displaying an inbound email as a list of sentences as segments, described above. For each sentence, the merchant can then include their own preferred response. This response is also displayed along with the corresponding input sentence. If the merchant does not include his or her own response, the response provided by chatbot system 108 (if any) is displayed.

Merchants can then edit the given responses or enter a new one if none is given. When merchants save the edits, chatbot system 108 stores each inbound sentence with its corresponding response (if any) and creates a content entry for loading onto chat engine 336. If an entry with the same input message pattern exists, that entry is overwritten with the new content entry.

Learning from External Replies

In another embodiment, chatbot system 108 can also learn from an inbound email message and its human reply that were transmitted to a user that sent the inbound email message. Here, chatbot system 108 regularly downloads the sent messages from the appropriate mail servers. Chatbot system 108 extracts the quoted text, e.g., lines set off by prefix “>” and the corresponding responses that follow each quoted text.

For each quoted text and response, chatbot system 108 generates a knowledge entry for loading. Merchants are typically requested to follow this specification for identifying quoted text, for example, when they provide replies from outside of the system.

Shared Content

In a further embodiment, knowledge base content for various systems can be shared by chatbot systems to increase available content. For example, knowledge base content for mail, live chat, automatic Twitter replies, etc., can be used by chatbot system 108. In such an embodiment, when content is created, the content is tagged with source associated with the content.

The source can be chat, mail, Twitter, etc. When such shared content is loaded for use by chatbot system 108, a higher priority is assigned to mail source content. Thus, the knowledge base content for chat or Twitter is used only if there is no matched content for mail.

Reply Keyword

When composing a reply, communication system 100 may insert a keyword, for example [Auto-reply 79870], in the subject line. When users or customers send a response to the reply, the system can identify this as a response to the reply. When composing a further reply to the response, the system may optionally use a third template, which can be simpler than that used in the first reply.

FIG. 7A shows a typical computer 10 such as would be operated by a user on the Internet and suitably programmed using one or more lines of code to execute embodiments of the present invention. Computer 10 includes a cabinet 12 housing familiar computer components such as a processor, memory, disk drive, Compact Digital Read-Only Memory (CDROM), etc. User input devices include keyboard 16 and mouse 18. Output devices include display 20 having a display screen 22. Naturally, many other configurations of a computer system are possible. Some computer systems may have other components in addition to those shown in FIG. 7A while others will have fewer components. For example, server computers need not have attached input and output devices since they may only be accessed from time to time by other computers over a network. Human interaction with such a server computer can be at another computer that is equipped with input and output devices. Input and output devices exist in many variations in addition to those shown in FIG. 7A. Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine.

The computer itself can be of varying types including laptop, notebook, palm-top, pen-top, etc. The computer may not resemble the computer of FIG. 7A as in the case where a processor is embedded into another device or appliance such as an automobile or a cellular telephone. Because of the ever-changing nature of computers and networks, the description of hardware in this specification is intended only by way of example for the purpose of illustrating the preferred embodiment. Any distributed networked system capable of executing programmed instructions is suitable for use with the present invention.

FIG. 7B shows subsystems of the computer of FIG. 7A. In FIG. 7B, subsystems within box 40 are internal to, for example, the cabinet 12 of FIG. 7A. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system, and some of the subsystems shown in FIG. 7B may be omitted. External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A method for generating email replies with personalized content in response to inbound email messages received from users, the inbound email messages having a plurality of text to which a response is desired, the method comprising:
determining which ones of said plurality of text to extract from a received inbound email message, the extracted text being configured to generate a plurality of sentences;
using said plurality of sentences as input messages to generate corresponding output messages that are responsive to said input messages, wherein each output message is generated based on a corresponding input message;
composing all of the output messages into an outbound email message that is responsive to said inbound email message; and
transmitting the outbound email message to a user.

2. The method of claim 1 further comprising providing a chatbot configured to receive the plurality of sentences as input messages and to generate the corresponding output messages that are responsive to said input messages.

3. The method of claim 1 wherein the plurality of text to extract from the inbound email messages is determined by creating a list of text patterns and excluding all text in the inbound email messages that match a text pattern

4. A method for generating email replies with personalized content in response to inbound email messages received from users, the method comprising:
extracting text from a received inbound email message, the text being configured to generate a plurality of sentences;
using said plurality of sentences as input messages to generate corresponding output messages that are responsive to said input messages, wherein each output message is generated based on a corresponding input message;
composing all of the output messages into an outbound email message that is responsive to said inbound email message; and
transmitting the outbound email message to a user.

5. The method of claim 4 wherein said input messages are received by a chatbot that then generates the corresponding output messages responsive to said input messages.

6. The method of claim 4 wherein each output message is configured for comparison with the received inbound email message to determine whether said output message is responsive to said inbound email message before the outbound email message is sent.

7. The method of claim 4 wherein if an output message is not responsive to the inbound email message or an inquiry sentence therein, said output message is configurable to receive a new sentence or an edited sentence responsive to the inquiry sentence in the inbound email message.

8. The method of claim 7 further comprising storing and associating the inquiry sentence with the edited sentence as an input/output message pair for the chatbot.

9. The method of claim 7 further comprising storing and associating the inquiry sentence with the new sentence as an input/output message pair for the chatbot.

10. The method of claim 1 further comprising using a first template for an opening paragraph of the outbound email message, using a second template for a closing paragraph of the outbound email message and inserting said output messages between the opening and closing paragraph before the outbound email message is transmitted.

11. A system operable to use an interactive display and a computer system capable of processing one or more lines of code, the system comprising:
one or more lines of code that extract text from a received inbound email message, the text being configured to generate a plurality of sentences;
one or more lines of code that use said plurality of sentences as input messages to generate corresponding output messages that are responsive to said input messages, wherein each output message is generated based on a corresponding input message;
one or more lines of code that compose all of the output messages into an outbound email message that is responsive to said inbound email message; and
one or more lines of code that transmit the outbound email message to a user.

12. The system of claim 11 wherein said input messages are received by a chatbot that then generates the corresponding output messages responsive to said input messages.

13. The system of claim 11 wherein each output message is configured for comparison with the received inbound email message to determine whether said output message is responsive to said inbound email message before the outbound email message is sent.

14. The system of claim 11 wherein if an output message is not responsive to the inbound email message or an inquiry sentence therein, said output message is configurable to receive a new sentence or an edited sentence responsive to the inquiry sentence in the inbound email message.

15. The system of claim 14 further comprising one or more lines of code that store and associate the inquiry sentence with the edited sentence as an input/output message pair for the chatbot.

16. The system of claim 14 further comprising one or more lines of code that store and associate the inquiry sentence with the new sentence as an input/output message pair for the chatbot.

17. The method of claim 4 further comprising using a first template for an opening paragraph of the outbound email message, and a second template for a closing paragraph of the outbound email message and inserting said output message between the opening and closing paragraph before the outbound email message is transmitted.
